(19) United States
(12) Patent Application Publication
(10) Pub. No.: US 2009/0051299 A1
(43) Pub. Date: Feb. 26, 2009

(54) LINEAR REACTOR BALLAST FOR SPORTS LIGHTING FIXTURES

(75) Inventors: MYRON K. GORDIN, OSKALOOSA, IA (US); TIMOTHY J. BOYLE, OSKALOOSA, IA (US)

Correspondence Address: MCKEE, VOORHEES & SEASE, P.L.C., 801 GRAND AVENUE, SUITE 3200, DES MOINES, IA, 50309-2721, US

(73) Assignee: MUSCO CORPORATION, OSKALOOSA, IA (US)

(21) Appl. No.: 12/261,839

(22) Filed: Oct. 30, 2008

Related U.S. Application Data
(63) Continuation of application No. 11/334,208, filed on Jan. 18, 2006.
(60) Provisional application No. 60/644,536, filed on Jan. 18, 2005.
(60) Provisional application No. 60/644,639, filed on Jan. 18, 2005.
(60) Provisional application No. 60/644,747, filed on Jan. 18, 2005.
(60) Provisional application No. 60/644,534, filed on Jan. 18, 2005.
(60) Provisional application No. 60/644,720, filed on Jan. 18, 2005.
(60) Provisional application No. 60/644,688, filed on Jan. 18, 2005.
(60) Provisional application No. 60/644,636, filed on Jan. 18, 2005.
(60) Provisional application No. 60/644,517, filed on Jan. 18, 2005.
(60) Provisional application No. 60/644,516, filed on Jan. 18, 2005.
(60) Provisional application No. 60/644,546, filed on Jan. 18, 2005.
(60) Provisional application No. 60/644,547, filed on Jan. 18, 2005.
(60) Provisional application No. 60/644,638, filed on Jan. 18, 2005.
(60) Provisional application No. 60/644,537, filed on Jan. 18, 2005.
(60) Provisional application No. 60/644,637, filed on Jan. 18, 2005.
(60) Provisional application No. 60/644,719, filed on Jan. 18, 2005.
(60) Provisional application No. 60/644,784, filed on Jan. 18, 2005.
(60) Provisional application No. 60/644,687, filed on Jan. 18, 2005.

(51) Int. Cl. H05B 37/02

(52) U.S. Cl. 315/291

(57) ABSTRACT

A means and method for increasing use of a light from a high intensity lighting fixture to a target area without an increase in energy use. One aspect increases the electrical efficiency of transmission of electrical power from an electrical power source to the lamp such that for the same cost of electrical energy, more electrical energy is available for production of light. Conversely less electrical energy could be purchased to produce the same amount of light. In another aspect electrical components along the electrical service path can be utilized with increased electrical efficiency towards the same end.

### CROSS REFERENCE TO RELATED APPLICATIONS

This application is a Continuation of U.S. Ser. No. 11/334,208 filed Jan. 18, 2006 which claims priority under 35 U.S.C. § 119 of a provisional application 60/644,516 filed Jan. 18, 2005, herein incorporated by reference in its entirety. This application is also a non-provisional of the following provisional U.S. applications, all filed Jan. 18, 2005: U.S. Ser. No. 60/644,639; U.S. Ser. No. 60/644,536; U.S. Ser. No. 60/644,747; U.S. Ser. No. 60/644,534; U.S. Ser. No. 60/644,720; U.S. Ser. No. 60/644,688; U.S. Ser. No. 60/644,636; U.S. Ser. No. 60/644,517; U.S. Ser. No. 60/644,609; U.S. Ser. No. 60/644,546; U.S. Ser. No. 60/644,547; U.S. Ser. No. 60/644,638; U.S. Ser. No. 60/644,537; U.S. Ser. No. 60/644,637; U.S. Ser. No. 60/644,719; U.S. Ser. No. 60/644,784; U.S. Ser. No. 60/644,687, each of which is herein incorporated by reference in its entirety.

This application also claims priority to co-pending U.S. Ser. No. 10/785,867 filed Feb. 24, 2004.

### INCORPORATION BY REFERENCE

The contents of the following U.S. Patents are incorporated by reference by their entirety: 4,816,974; 4,947,303; 5,161,883; 5,600,537; 5,816,691; 5,856,721; 6,036,338.

The contents of published U.S. Application 2005/0184681 (Ser. No. 10/785,867) is incorporated by reference in its entirety.

### BACKGROUND OF THE INVENTION

A. Field of the Invention

The present invention relates to lighting fixtures that produce high intensity, controlled, and concentrated light beams for use at relatively distant targets. In particular, the invention relates to such lighting fixtures, their methods of use, and their use in systems where a plurality of such fixtures are used in combination, usually elevated on poles, to compositely illuminate a target area energy-efficiently, with reduced glare and spill light, and with the capability to lower capital and/or operating costs. One primary example is illumination of a sports field.

B. Problems in the Art

Economics plays a big part in most sports lighting. Prime sports lighting customers include entities such as school districts, municipal recreation departments, and private sports leagues. Such entities are particularly sensitive to cost. It would be easier, of course, to meet light quantity and uniformity specifications for a field if one hundred light fixtures on ten poles were erected. The lighting designer could make sure that more than required light is supplied to the field and the volume of space above the field. However, the cost would be prohibitive for most customers. As sports lighting is not usually a necessity, it likely would not be purchased.

Efforts have gone towards developing increasingly more powerful lamps for sports lighting. However, while producing more lumen output, they require more electrical power to operate. More light per fixture may reduce the number of fixtures and poles, but would increase the amount of electrical energy per fixture used. A typical sports light may be used only a couple of hours a day, on average. Several decades, at least, is the expected life of a sports lighting system. Therefore, energy costs become significant, particularly over those lengths of time.

It would be beneficial to optimize the amount of light generated by a fixture or set of fixtures per unit electrical energy used.

### SUMMARY OF THE INVENTION

Light energy has a cost. Each sport lighting system consumes a significant amount of electrical energy to produce light from each fixture. As illustrated in FIGS. 1B-1F, each fixture 2 receives electrical power from an electrical power source (commercial or residential service) via an electrical system 9, which normally distributes electricity first through a centralized junction box or cabinet for the particular system (FIG. 1C), then to a ballast box at each pole 6 (FIGS. 1B and C), and then via wiring to each fixture 2 (FIGS. 1B, D-F). The typical components of sports lighting systems are designed to last for hopefully decades, with periodic replacement of lamps as needed. The present invention takes into account not only cost of hardware and its installation, but how effectively it produces light and uses electrical energy over its operating life.

The subtlety is that most sports lighting systems are operating a relatively small fraction of the time. For example, even if used every night, it might only be for 2-4 hours. However, over 10 years, this can mean thousands of hours of operation. Per fixture, the amount of energy cost per day or even year may not look significant. However, taking a wider view, energy costs for thirty fixtures, for example, over 10 years, is significant. This would be for just one sports field. Multiplied by the number of sports fields lighted in the world, reduction in energy consumption, while maintaining acceptable light at the fields, would be significant.

The present invention addresses more efficient production of light relative to amount of energy used in the design of the types of light fixtures used in sports lighting systems.

One issue addressed by the present invention is the efficient production of light. This has several connotations. One is reducing the amount of energy needed to achieve a certain light level and uniformity at a target. However, another can be increasing the amount of useful light for the target from a given amount of energy.

A. Objects, Features, or Advantages, of the Invention

It is therefore a principal object, feature, or advantage of the present invention to present a high intensity lighting fixture, its method of use, and its incorporation into a lighting system, which improves over or solves certain problems and deficiencies in the art.

Other objects, features, or advantages of the present invention include such a fixture, method, or system which can increase the amount of useable light at each fixture for a fixed amount of energy;

B. Exemplary Aspects of the Invention

An aspect of the invention comprises a method and apparatus for increasing the amount of electrical energy available to power the lamp without increasing the amount obtained from the electrical service. One example is use of a more energy efficient ballast circuit than is conventional. While such increases in efficiency are relatively small in absolute magnitude at any one time, over the several thousand hours of operation of such lamps, cumulatively they can be very significant.

These and other objects, features, advantages and aspects of the present invention will become more apparent with reference to the accompanying specification and claims.

### BRIEF DESCRIPTION OF THE DRAWINGS

FIG. 1A and its sub-parts B-F illustrate generally a sports lighting system, and conventional components for a sports lighting system.

### DETAILED DESCRIPTION OF EXEMPLARY EMBODIMENTS

### A. Overview

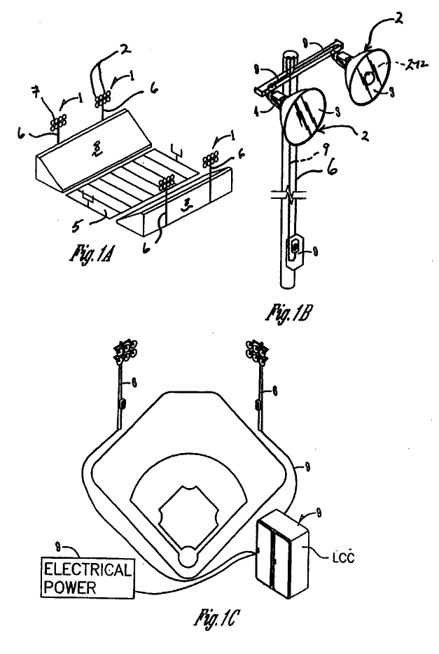

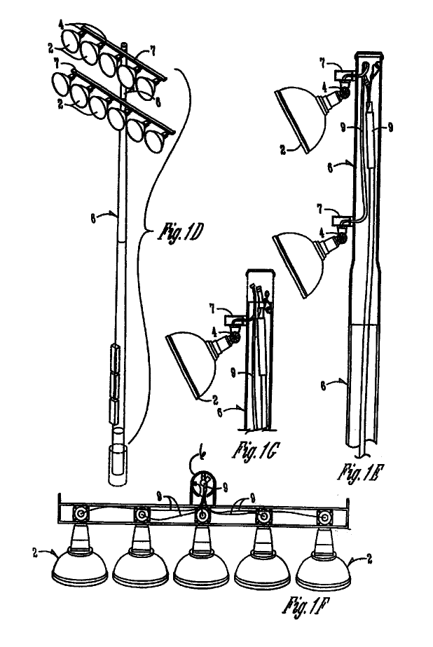

An embodiment of a light fixture will be described in the context of sports lighting, sports lighting fixtures, and sports lighting systems for the illumination of athletic fields such as shown in FIGS. 1A and 1C. The lighting must light the field and a volume of space above the field (collectively sometimes called the target area or target space), according to predetermined lighting level and uniformity specifications. The embodiment relates to fixtures that utilize high intensity discharge (HID) lamps, presently normally 1,000 watts or higher, of the metal halide type. Such installations generally have several arrays of fixtures usually elevated on two or more relatively tall poles (35 feet to 100 or more feet). Electrical power to the systems normally comes from commercial service to a control cabinet. Electrical power is then distributed out to individual poles having individual ballast boxes which, with wiring, distribute electrical power to each light fixture at the top of each pole (see, e.g., FIGS. 1A-1E).

In this context, the athletic field is therefore the target area or space. There could be more than one target area per sports facility. It is to be understood, however, that the present invention has applicability to other applications utilizing these or other HID lamps, and is not limited just to these types of HID lamps or to sports lighting.

### B. Exemplary Apparatus

1. Linear Reactor Ballast/More Electrically Efficient Components

A linear reactor ballast is used to supply fixture 10 with electrical energy. Such linear reactor ballasts are available commercially and have increased electrical efficiency over conventional ballasts. They can add several percent more light generated from lamp 20 for the same amount of energy used. Published application US 2005/0184681 describes an example.

Alternatively or in addition, components transmitting electrical energy to lamp 20 for fixture 10 can provide added electrical energy to lamp 20. For example, higher magnetic permeability steel for the ballasts has been discovered to allow an increase of wattage available to arc lamp 20 for the same amount of energy used.

Electrical power from a control cabinet is connected to each ballast box on each pole. When the lighting system is turned on, it will:
For the given amount of operating energy from an electrical service; produce more lumens per fixture because of less energy loss between the electrical service and the lamps because of linear reactor ballasts and decrease electrical energy loss between electrical power service and arc lamp by high efficiency ballast.

2. Summary of Benefits of Fixture 10 and its Operation

Utilization of electrical components that increase the amount of electrical energy between the electrical surface and lamp 20 is an option to increase lumen output and thus more light the field for a given initial quantity of energy used.

As indicated earlier, if electrical energy to operate the lamp could be more efficiently translated from the electrical power source, it could increase the amount of lumen output of the lamp for a given amount of energy used and thus translating the more light to the field. An example is the use of a linear reactor ballast. With a conventional choke, the power factor is wasteful, especially at starting of the lamp. The linear reactor ballast provides more energy efficiency. This can add to the overall cumulative efficiency of fixture 10 by supplying more electrical power to the lamp from the electrical power purchased from the electrical service. An increase in useful light can come about by this addition for the same amount of energy input.

Alternatively, or in addition, an increase in wire size and/or an increase in the magnetic permeability of the ballast material for the ballasts for fixture 10 would decrease electrical resistance and, thus, power loss in the transmission of electrical energy to lamp 20. Even such steps can increase on the order of 50 watts available for powering the HID lamp. This could result in additional light useable at the field for a given amount of electrical energy used.

### C. Options and Alternatives

It will be appreciated that the foregoing exemplary embodiment is given by way of example only and not by way of limitation. Variations obvious to those skilled in the art will be included in the invention. The scope of the invention is defined solely by the claims.

For example, variations in dimensions, materials, and combinations are contemplated by the invention. In particular, all of the features and aspects of the exemplary embodiment are not required to produce a beneficial or advantageous result.

1. Application Alternatives

The invention can be utilized for other wide area lighting applications other than sports lighting. A few examples are parking lot lighting, architectural lighting, public event lighting, arena or stadium lighting. It can be applied to interior lighting. It is relevant to any HID fixture where a controlled concentrated beam is desired or needed. This includes to a relatively distant (e.g. on the order of 100 feet or more) target, or for special effects lighting.

1. A method for increasing useable light from a high intensity lighting fixture to a target area without an increase in energy use, the lighting fixture including an arc tube substantially surrounded by a reflecting surface and a glass lens to produce a controlled, concentrated beam that is generally converging in nature from the fixture, comprising:
a. increasing lamp lumen output without an increase in operating energy by increasing electrical efficiency of transmission of electrical power from an electrical power source to the lamp.

2. The method of claim 1 wherein the increase of electrical efficiency comprises placing a more efficient lamp ballast between the electrical power source and the lamp.

3. The method of claim 2 wherein the more efficient lamp ballast is a linear reactor ballast.

4. The method of claim 1 wherein the increase of electrical efficiency comprises decreasing resistance in the electrical transmission path between the electrical power source and the lamp.

5. The method of claim 4 wherein the decreased resistance comprises placing larger, and thus lower resistance, wire in the electrical transmission path.

6. The method of claim 4 wherein the decreased resistance comprises using greater higher magnetic permeability ballast material in the lamp ballast in the electrical transmission path.

7. A high intensity lighting fixture for increasing useable light to a target area without an increase in energy use comprising:
a. a lamp cone;
b. a knuckle attachable to the lamp cone for use in adjustable mounting to a cross-arm or other suspending structure;
C. a reflector mountable to the lamp cone and comprising a bowl-shaped, and a primary opening over which a glass lens is mountable;
d. a high intensity discharge lamp having a base mountable into the lamp cone and an arc tube positionable in the interior of the reflector frame substantially surrounded by the reflector;
e. a linear reactor lamp ballast between the electrical power source and the lamp.

8. The lighting fixture of claim 7 in combination with a decreased resistance electrical transmission path between an electrical power source and the lamp.

9. The lighting fixture of claim 8 wherein the decreased resistance electrical transmission path comprises larger, and thus lower resistance, wire.

10. The lighting fixture of claim 8 wherein the decreased resistance electrical transmission path comprises more highly magnetic permeable ballast material in a lamp ballast for the lamp.

11. In a high intensity light fixture having a power source for providing electrical energy and a lamp for converting electrical energy to light, an improved circuit for transferring and regulating electrical energy from the power source to the lamp, the circuit comprising:
a ballast for regulating the amount of energy delivered to the lamp; and
a power transfer conduit for delivering electrical power from the power source to the ballast;
wherein the ballast and power transfer conduit comprise energy efficient materials selected so as to reduce energy loss during operation.

12. The circuit of claim 11 wherein the energy efficiency of the ballast is achieved by selecting a linear reactor ballast.

13. The circuit of claim 11 wherein the power transfer conduit comprises a low resistance wire.

14. The circuit of claim 13 wherein the low resistance of the wire is achieved by selecting a wire having increased diameter over the minimally required size.

15. The circuit of claim 11 wherein the lamp comprises a high intensity discharge lamp.

16. The circuit of claim 11 wherein the lamp comprises a high intensity discharge lamp.

17. A high intensity lighting fixture and circuit for increasing useable light to a target area without an increase in energy use comprising:
a high intensity discharge lamp having an arc tube; and
a lamp circuit comprising a lamp ballast having electrical power source connections and operatively connected to the high intensity discharge lamp by lower resistance wires so that there will be less power loss between an electrical power source and the lamp to produce more lumen output from the lamp for a given input power from an electrical power source.

18. The high intensity lighting fixture and circuit of claim 17 further comprising a lamp cone.

19. The high intensity lighting fixture and circuit of claim 18 wherein the high intensity discharge lamp further has a base mountable into the lamp cone.

20. The high intensity lighting fixture and circuit of claim 19 further comprising a knuckle attachable to the lamp cone for use in adjustable mounting to a cross arm or other supporting structure.

21. The high intensity lighting fixture and circuit of claim 20 further comprising a reflector mountable to the lamp cone and comprising a bowl-shape, and a primary opening over which a glass lens is mountable.

22. The high intensity lighting fixture and circuit of claim 21 wherein the arc tube is positionable in the interior of the reflector frame so that it is substantially surrounded by the reflector.

23. The high intensity lighting fixture and circuit of claim 17 wherein the lamp ballast comprises a linear reactor lamp ballast.
